(19) United States
(12) Patent Application Publication
(10) Pub. No.: US 2004/0030577 A1
(43) Pub. Date: Feb. 12, 2004

(54) Automated risk management infrastructure for healthcare

(76) Inventors: William R. Bitman, Baltimore, MD (US); Amy K. Karlson, Ellicott city, MD (US); David P. Silberberg, Baltimore, MD (US); Claire B. Rosse, Phoenix, MD (US); Francis B. Woiskopf Jr, Catonsville, MD (US)

Correspondence Address: Francis A Cooch Office of Patent Counsel, The Johns Hopkins University, Applied Physics Laboratory, 11100 Johns Hopkins Road, Laurel, MD, 20723-6099, US

(21) Appl. No.: 10/240,480

(22) PCT Filed: Apr. 5, 2001
(86) PCT No.: PCT/US01/11129

(51) Int. Cl. G06F 17/60

(52) U.S. Cl. 705/2

(57) ABSTRACT

A method for obtaining patient information for processing by an independent screening database. Queries regarding beliefs and behaviors concerning disease management and compliance are receiving from the screening database. The queries are posed utilizing standard graphical user interfaces. Answers to the queries are input utilizing the graphical user interface classes. The patient answers are transmitted to the screening database.

### BACKGROUND OF THE INVENTION

1. Field of the Invention

The present invention relates to the process, knowledge and environment for assessing, characterizing and managing disease-specific health care compliance. In doing so, the present invention can help to manage consumption of medical resources by a portion of a patient population most at risk to over consume medical resources as well as facilitating identification of these patients. Particularly, the invention provides a semi-automated environment that enables a process in which health care providers seamlessly interact with a patient to evaluate their compliance with the specified health care protocol, assess their beliefs and behavior regarding compliance management, identify issues in compliance management, and/or design and implement a compliance management plan. The environment enables aggregation of system performance that enables knowledge accretion and system improvement. These capabilities are applicable to a broad range of heath care management tasks. The software environment is also adaptable to a broad range of behavior modification and self help applications including applications such as monitoring current wellness state.

2. Description of the Related Art

Healthcare costs continue to escalate at a steep rate. Cost increases have occurred in all areas, including insurance premiums, medical equipment, medicines and costs for visits to doctors. A great deal of energy has gone into finding ways to reduce healthcare costs, from government control of aspects of health care to insurance company managed care plans to control patient utilization of the healthcare system and provider actions.

Systems have been created to institute a process that automatically generates a database of candidate at risk patients. The process of identifying the patients can be fully automated. Along these lines, insurance records in electronic medium can be processed using the software that produces a database of at risk patients. This is one source of candidate patients for the present invention. Patients could also be selected manually by health care workers. Some known systems include a suite of knowledge sets for assessing and managing compliance with medical protocols. The knowledge sets can specify cause and effect behavior that relates patient beliefs and behavior to compliance management issues. Such knowledge sets can serve as a source of knowledge utilized by the present invention as described below in greater detail.

### SUMMARY OF THE INVENTION

The present invention provides protocols and environment for applying knowledge to health care risk management. The protocols and environment identify a sequence of actions and knowledge sets based on patient information that may be involved in health care risk management. The protocols and environment for identified at risk patients can include assessing compliance risk, establishing compliance goals, identifying and applying required interventions, and collecting and annotating medical information relevant to the compliance management process. The environment provides a suite of software tools that seamlessly couple the protocols and knowledge in a health care provider intuitive fashion.

The present invention includes a computer software environment and systems architecture. The computer software includes a computer readable medium and computer program instructions recorded on the computer readable medium and executable by a processor for performing the steps of the method of the present invention. The system architecture design enables reconfiguration to many client-server implementations to support different business models. For example, the present invention can support a standalone platform, a local area network, and/or world wide web implementations. The architecture may be based on Java technology that ensures portability and platform independence. The architecture can leverage the Java Enterprise technology, which provides for flexibility and incorporation of enterprise support services such as transaction management and security capabilities. Furthermore, the architecture is constructed using object technology that mirrors the problem domain taxonomy.

Still other objects and advantages of the present invention will become readily apparent by those skilled in the art from a review of the following detailed description. The detailed description shows and describes preferred embodiments of the present invention, simply by way of illustration of the best mode contemplated of carrying out the present invention. As will be realized, the present invention is capable of other and different embodiments and its several details are capable of modifications in various obvious respects, without departing from the invention. Accordingly, the drawings and description are illustrative in nature and not restrictive.

### BRIEF DESCRIPTION OF THE DRAWINGS

Objects and advantages of the present invention will be more clearly understood when considered in conjunction with the accompanying drawings, in which:

FIG. 1 represents a schematic drawing that illustrates aspects of the process according to an embodiment of the present invention;

FIG. 2 represents a schematic drawing that illustrates aspects of an embodiment of the compliance management step in the process according to the present invention;

FIG. 3 represents a schematic drawing that illustrates aspects of compliance management regarding the process of compliance planning, patient interaction for intervention and assessment, results collection, and recording in the patient profile;

FIG. 4 represents a schematic drawing that illustrates aspects of knowledge accretion and system improvement according to the present invention;

FIG. 5 represents a schematic drawing that illustrates aspects of the architecture in three different embodiments of a health care risk management system;

FIG. 6 represents a schematic drawing of the common modular architecture, and

FIG. 7 represents a block diagram that illustrates aspects of an embodiment of a system according to the present invention.

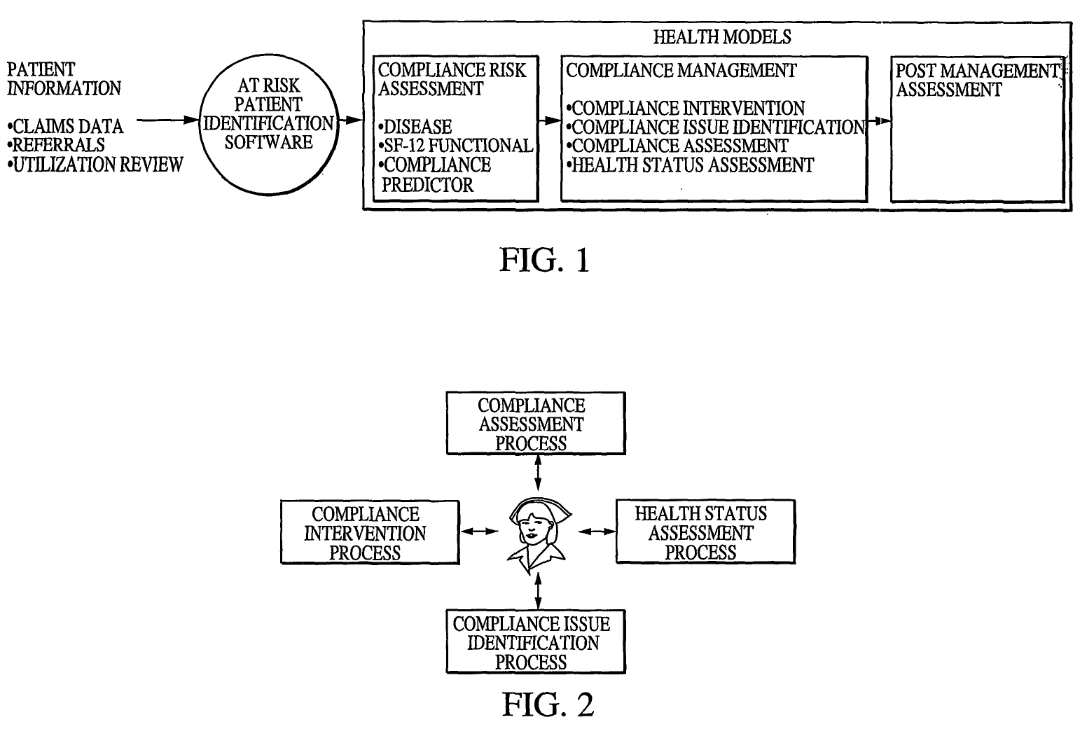

### DESCRIPTION OF THE PREFERRED EMBODIMENT(S)

It has been determined that a small percentage of patients consume a significant portion of the health care plan's resources. This is particularly true in managed health care plans. Consequently, in an attempt to contain health care costs, it is desirable to address the issue of patient that consume a significant share of medical resources. This represents just another means of managing health care costs. The present invention addresses this problem by providing a way to identify these patients in the overall population of a healthcare plan and then manage their utilization of medical resources to control costs and more effectively deliver care to both the high utilization patients as well as all patients in the system.

Like many other areas of activity, healthcare can benefit from automated/semiautomated processes such as decision aids for patient case management and data bases that collect patient specific performance for process improvement techniques that have been so useful in business today. In addition, data mining techniques can be utilized in health care to discover relationships among data that it would otherwise be impossible or impractical to obtain manually. These new relationships allow for process improvement, which in turn produces new relationships. Thus, the present invention provides a foundation and automated method for a learning organization

The present invention provides a protocol and environment, or software, to manage risk in healthcare and to assist in compliance management. Patients can enter the process through various mechanisms. In particular, identification of at risk patients can take place automatically through processing insurance records in electronic form. Among the aspects of the records that are analyzed are claims data, prescription data, referral data, and a review of overall utilization. Patients can also enter through referrals.

Steps are carried out to reduce the cost of caring for these patients yet maintain an adequate level of care. Once these patients are identified, each patient is interviewed for compliance risk assessment. Assessing at risk patients can include posing a series of questions to the patients. The questions can evaluate a number of aspects of the patient's attitudes, including their beliefs and behaviors regarding their health, attitudes toward their health, managing their health and the healthcare system and/or any other topic. Examples of questions can include questions on the SF-12 health survey. More information on the SF-12 can be found at the following internet site http://qmetric.com/innohome/insf12.shtml, the entire contents of which and all linked sites are hereby incorporated by reference. Analysis of the patients' answers to the questions can reveal patients' relative risk with respect to compliance with a treatment regimen and predict patient compliance with the regimen. In some cases, some of the at risk patients may be eliminated from further consideration by the system if their score indicates that they are not really at risk, or their beliefs indicate noncompliance.

A nurse, physician or other person may pose the questions to the patients. In such an embodiment, the questions could be posed in person or over the telephone. The questioner could pose questions from a printed list of questions. On the other hand, the questions may be generated by a computer system and displayed on a graphical user interface (GUI) where the questioner can read them. The questioner can write down the answers or enter them into the GUI and the answers are stored in a database.

According to another embodiment, the internet is utilized to conduct patient compliance risk assessment. A patient would access a web site. The web site would prompt the patient for a password or some other identifying number that will permit a server to identify the patient and access the patient's profile. After identifying a patient, the questions would be transmitted to the patient via the internet. Subsequently, the patient's answers would be transmitted over the internet to a compliance risk assessment system.

Regardless of how the questions are posed to the patients, the questions are tightly coupled to the specific patient circumstances, including disease and health status. Patient responses are stored in a patient profile data set. Each patient has a patient profile, which contains a dynamic representation of the patient's current state. Patient responses may invite a new series of questions—the questions adapt to the responses. The adaptation process may be continued throughout the questioning. Along these lines, as answers are received to questions, a decision tree may be utilized to guide the questioning. The questioning may be stopped by the questioner or may be automatically terminated by a computer system. Termination of the questioning may take place upon reaching a certain point or may be terminated by the questioner, the patient or the system at an arbitrary point.

Additionally, numerical values may be attached to answers to any or all of the questions. Assigning values to the answers can permit a more objective representation of the patient's compliance risk status to be developed. Also, quantifying patient responses can lead to more standardized care at least in part by replacing judgement calls by questioners with more standardized operations.

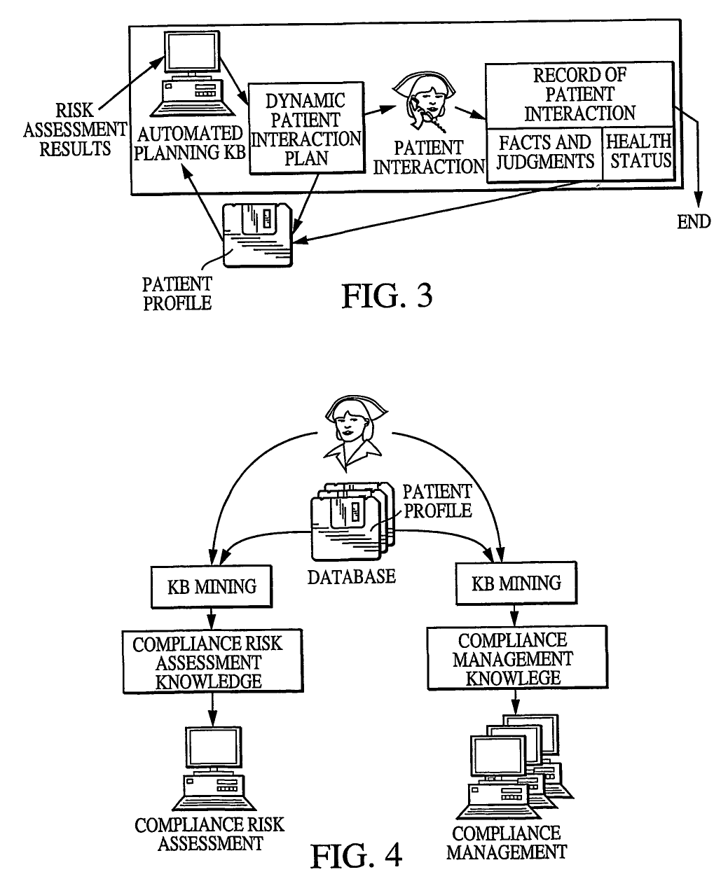

If the assessment process leads to identifying a patient as at risk a provider, whether a nurse, physician, nurse practitioner, physician's assistant or other person, may be assigned to a patient to develop, implement, and/or ensure compliance with a course of action. The adaptive decision tree can be employed to guide the caregiver to an appropriate course of action. In fact, the course of action may be continuously modified as patient attitudes and behavior changes, as reflected by continued interaction with the system. FIG. 3 illustrates this process.

As can be seen in FIG. 3, the results of the patient interviews performed in Risk Assessment provide the initial data used to form the plan to manage patient compliance. Patient interactions are recorded. These interactions can include facts and judgements as well as the patient's health status. The interaction and record thereof can go into developing the patient profile. Furthermore, the patient profile is used by the plan to adapt the compliance management process.

FIG. 2 illustrates aspects of this portion of the present invention. During compliance management, interaction with the patient typically continues. Along these lines, assessment may continue of patient beliefs and behavior, particularly behavior with respect to carrying out the course of action, or care plan, developed for the patient. Along these lines, questions may be posed to the patient regarding particular issues that exist in their care plan. If necessary, the care plan may be altered through time to help ensure patient compliance and/or to adapt to changing circumstances, such as changing health status. Also if necessary, a health care worker may intervene to help ensure compliance.

FIG. 4 illustrates the process of knowledge base mining. The contents of the patient profile database are the resource used in knowledge mining techniques. The techniques extract additional risk assessment and compliance management knowledge that can be subsequently used in the process.

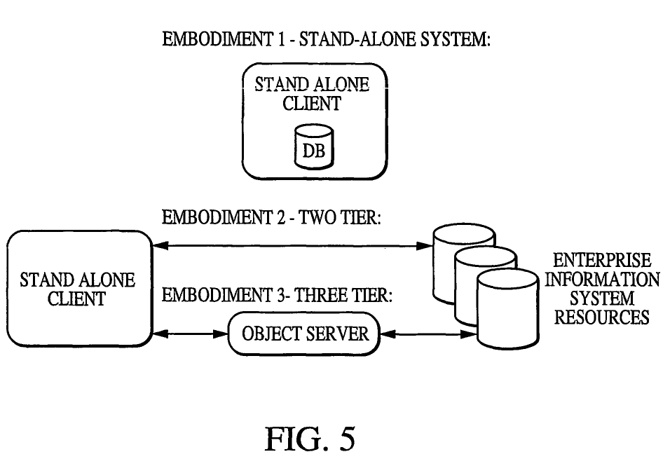

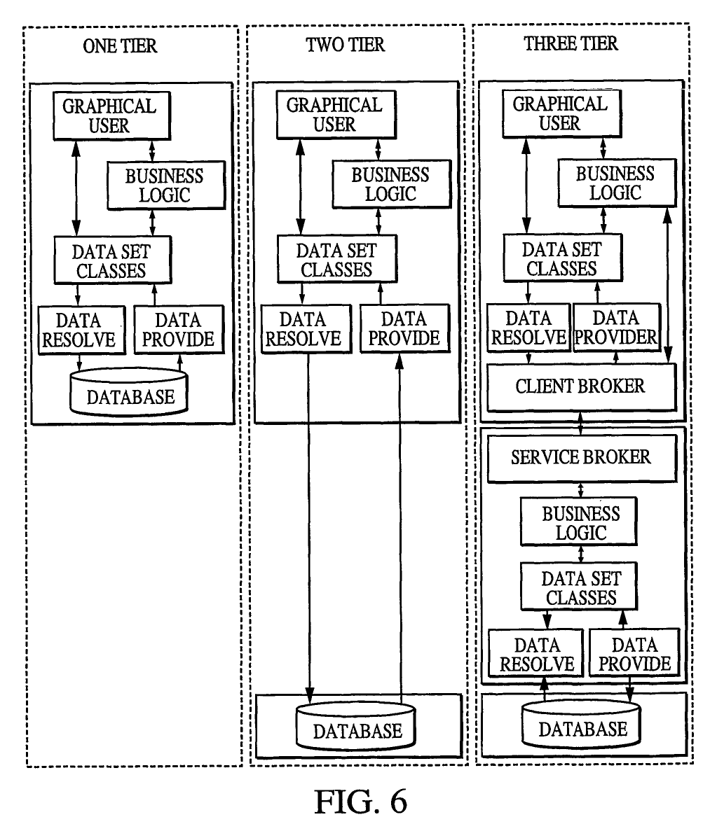

FIG. 5 illustrates various embodiments of a system according to the present invention. FIG. 6 illustrates in greater detail one, two, and three tier business models. As illustrated in FIG. 6, software according to the present invention may be built using finctional building blocks, including user interface classes, business logic classes, data set classes, data provider classes, data resolver classes, class stubs, and the database. This functional decomposition allows for an architecture that can replicate and distribute the building blocks as necessary to seamlessly support one-, two-, and three tier business models as shown in FIG. 6.

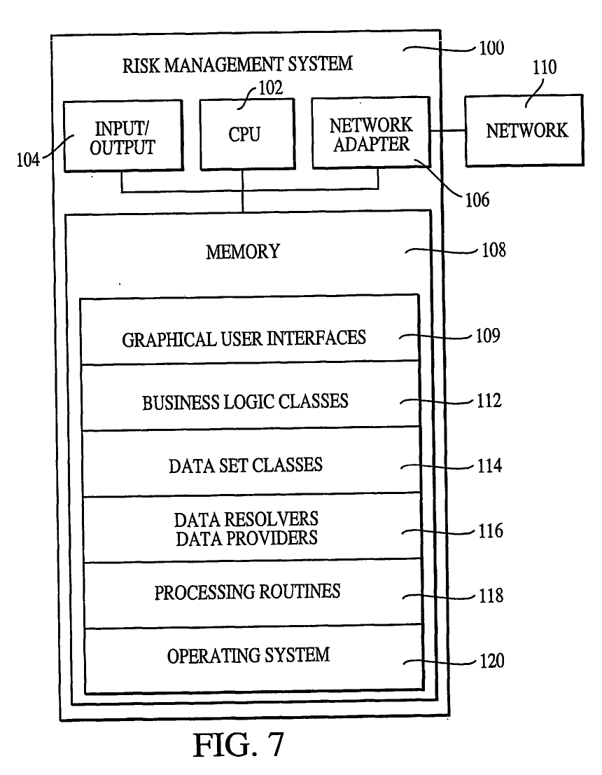

FIG. 7 illustrates an exemplary block diagram of a system according to the present invention. System 100 is typically a programmed general-purpose computer system, such as a personal computer, workstation, server system, and minicomputer or mainframe computer. Risk management system 100 includes processor (CPU) 102, input/output circuitry 104, network adapter 106, and memory 108. CPU 102 executes program instructions in order to carry out the functions of the present invention. Typically, CPU 102 is a microprocessor, such as an INTEL PENTIUM® processor, but may also be a minicomputer or mainframe computer processor. Input/output circuitry 104 provides the capability to input data to, or output data from, computer system 100. For example, input/output circuitry may include input devices, such as keyboards, mice, touchpads, trackballs, scanners, etc., output devices, such as video adapters, monitors, printers, etc., and input/output devices, such as, modems, among other elements. Network adapter 106 interfaces risk management system 100 with network 110. Network 110 may be any standard local area network (LAN) or wide area network (WAN), such as Ethernet, Token Ring, the Internet, or a private or proprietary LAN/WAN.

Memory 108 stores program instructions that are executed by, and data that are used and processed by, CPU 102 to perform the functions of the present invention. Memory 108 may include electronic memory devices, such as random-access memory (RAM), read-only memory (ROM), programmable read-only memory (PROM), electrically erasable programmable read-only memory (EEPROM), flash memory, etc., and electromechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSL, fast and wide-SCSI, etc, or a fiber channel-arbitrated loop (FC-AL) interface.

Memory 108 includes a plurality of blocks of data, such as graphical user interface classes block 109, business logic classes block 112, data set classes block 114, and data resolvers and data providers block 116, and a plurality of blocks of program instructions, such as processing routines 118 and operating system 120. Graphical user interface classes block 109 stores elements of the graphical user interface included in the present invention Business logic classes block 112 stores a plurality of business logic classes that may be employed in the system. Data set classes block 114 stores data set classes. Data resolvers and data providers block 116 stores data resolvers and data providers that may interface with the database. Processing routines 118 are software routines that implement the processing performed by the present invention. Operating system 120 provides overall system functionality.

It is important to note that while the present invention has been described in the context of a fully functioning information processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as floppy disc, a hard disk drive, RAM, and CD-ROMs, as well as transmission-type media, such as digital and analog communications links.

Advantages of the present invention can include:

1. Eliminating the need to manually review documentation to determine patient health care utilization patterns;

2. Reliable, thorough and consistent application of compliance risk assessment and compliance management knowledge;

3. Quantified and traceable measures of effectiveness for the process;

4. Software environment tightly integrated with medical protocol;

5. Software architecture that enables multi-platform, multi-business model implementation;

6. Software architecture that allows encapsulated knowledge that is readily extendible;

7. Software architecture that couples to an independent database; and

8. Standardized interfaces for case management softwar outcomes analysis. Through the present invention, health care costs may be managed and hopefully reduced.

The foregoing description of the invention illustrates and describes the present invention. Additionally, the disclosure shows and describes only the preferred embodiments of the invention, but as aforementioned, it is to be understood that the invention is capable of use in various other combinations, modifications, and environments and is capable of changes or modifications within the scope of the inventive concept as expressed herein, commensurate with the above teachings, and/or the skill or knowledge of the relevant art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

We claim:

1. A method for obtaining patient information for processing by an independent screening database, the system comprising:
receiving from the screening database queries regarding beliefs and behaviors concerning disease management and compliance;
posing the queries utilizing standard graphical user interfaces;
entering answers to the queries utilizing the graphical user interface classes; and
transmitting the patient answers to the screening database.

2. The method according to claim 1, further comprising:
implementing the method with a software architecture tightly integrated with medical protocol and coupled to an independent database, the software operable to enable multiplatform and multi-business model implementation and operable to produce quantified and traceable measures of effectiveness for a patient management process, the software comprising standard interfaces for case management and reporting outcomes analysis.

3. The method according to claim 1, wherein the system is implemented on a standalone computer including the screening database.

4. The method according to claim 1, wherein the system is implemented on a computer that is operatively connected to a computer including the database.

5. The method according to claim 1, wherein the queries are posed to the patient from the graphical user interface via another person.

6. A system operable to obtain readily extendible encapsulated knowledge regarding a patient, the system comprising:
software architecture tightly integrated with medical protocol and coupled to an independent database, the software operable to enable multi-platform and multi-business model implementation and operable to produce quantified and traceable measures of effectiveness for a patient management process, the software comprising standard interfaces for case management and reporting outcomes analysis.

7. The system according to claim 6, wherein the software comprises a plurality of functional building blocks comprising graphical user interface classes, business logic classes, data set classes, data resolvers, and data providers.

8. The system according to claim 7, wherein the functional building block classes are replicable and distributable to seamlessly support a business model comprising at least one tier.

9. The system according to claim 8, wherein the business model comprises two tiers with the database remote from a processor on which the software runs.

10. The system according 8, wherein the business model comprises three tiers, the software further comprising a client broker and a server broker, the client broker comprising business logic stubs, data set classes, data resolver stubs, and data provider stubs, the server broker comprising business logic classes, data set classes, data resolvers, and data providers.

11. The system according to claim 6, wherein the software comprises a plurality of functional replicable and distributable building block classes operable to seamlessly support a business model comprising one tier to three tiers.

12. A protocol for health care risk management, comprising:
screening the identified at risk patients to assess risk and compliance;
developing a care plan; and
managing patient compliance with the care plan based upon the assessed risk and compliance.

13. The protocol according to claim 12, wherein screening identified at risk patients comprises:
retrieving questions from independent knowledge base
collecting responses from the identified at risk patients to questions regarding beliefs and behaviors concerning disease management and compliance;
assessing current medical state; and
assigning a score corresponding to the responses.

14. The method according to claim 13, where in the modes of interaction include at least one of the following:
at least one of the function of presenting the questions to the identified at risk patients and collecting the answers is performed electronically.
health care provider asks questions verbally and records answers electronically.

15. The method according to claim 13, further comprising:
developing patient risk management profiles comprising the assessment of patient compliance risk and the information from the compliance management process; and
retrieving and displaying the questions to the identified at risk patients according to the patient risk management profile.

16. The method according to claim 12, wherein managing patient compliance comprises collecting responses from the at risk patients regarding compliance with disease management protocols and to assess general health of the at risk patients, compliance planning, identifying compliance issues, compliance assessment, and health status assessment, wherein compliance planning comprises identifying intervention steps for the patient, compliance issues comprises identifying gaps in patients' understanding of compliance process, compliance assessment comprises evaluating patients' compliance with medical protocols and goals, and health status assessment comprises collecting, annotating, and storing compliance-relevant health information.

17. The method according to claim 16, where the patients are interacted with in at least one of the following manners:
electronically performing at least one of the function of presenting the questions to identified at risk patients and collecting the answers; and
a health care provider posing questions to identified at risk-patients and verbally and records answers electronically.

18. The method according to claim 12, further comprising:
quantifying compliance-relevant beliefs and behaviors based upon the compliance risk assessment.

19. The method according to claim 12, wherein managing patient compliance comprises:
compliance planning, identifying compliance issues, compliance assessment, health status assessment.

20. The method according to claim 12, wherein managing patient compliance comprises:
designing and implementing a care plan;
evaluating compliance with the care plan;
assessing patient beliefs and behavior; and
identifying issues in compliance;
wherein compliance planning comprises identifying intervention steps for the patient, compliance issues comprises identifying gaps in patients' understanding of compliance process, compliance assessment comprises evaluating patients' compliance with medical protocols and goals, and health status assessment comprises collecting, annotating, and storing compliance-relevant health information.

21. The method according to claim 12, further comprising:
accumulating a database of patient risk management profiles; and
extracting knowledge from the database regarding risk assessment knowledge and patient compliance knowledge for knowledge accretion and process improvement.

22. The method according to claim 12, wherein at least a portion of the method takes place in one of these modes:
stand-alone system;
local/wide area networks; and
the internet.

23. A computer program product for performing a process of obtaining information from a patient, the computer program product comprising:
computer program instructions, recorded on the computer readable medium, executable by a processor, for performing the steps of:
receiving from the screening database queries regarding beliefs and behaviors concerning disease management and compliance;
posing the queries utilizing graphical user interfaces;
entering answers to the queries utilizing the graphical user interface classes; and
transmitting the patient answers to the screening database.

24. A system for performing a process of obtaining information from a patient, the system comprising:
a processor operable to execute computer program instructions; and
a memory operable to store computer program instructions executable by the processor, for performing the steps of:
receiving from the screening database queries regarding beliefs and behaviors concerning disease management and compliance;
posing the queries utilizing standard graphical user interfaces;
entering answers to the queries utilizing the graphical user interface classes; and
transmitting the patient answers to the screening database.
